(19) United States
(12) Patent Application Publication
(10) Pub. No.: US 2004/0184654 A1
(43) Pub. Date: Sep. 23, 2004

(54) Optimizing selection of reference markings used in estimating the position of an imaging device

(76) Inventor: Nicolas Villain, Clamart (FR)

Correspondence Address: US Philips Corporation, Intellectual Property Department, P O Box 3001, Briarcliff Manor, NY, 10510, US

(21) Appl. No.: 10/482,142

(22) PCT Filed: Jul. 4, 2002
(86) PCT No.: PCT/IB02/02740

(30) Foreign Application Priority Data
Jul. 4, 2001 (EP) 01401791.7

(51) Int. Cl. G06K 9/00

(52) U.S. Cl. 382/151

(57) ABSTRACT

A method of estimating the position of the field of view of an imaging device, such as a camera, relative to a board involves designating groups of markings on the board as reference groups and detecting the respective shifts in a set of these reference groups within the field of view of the camera compared to known positions therein. A choice is made between the various possible sets of unambiguously-identifiable reference groups to be used for position estimation. This choice is based on a genetic algorithm optimization process in which the individuals in the population are different sets of candidate reference groups, a plurality of generations of individuals is generated, and the individual having the highest measure of a fitness parameter is selected to provide the set of reference groups to be used in position estimation. Advantageously, detection and localization of the reference groups involves analysis of only respective subsets of the image produced by the imaging device.

The present invention relates to the field of position estimation and, more particularly, to a method of estimating the position of the field of view of an imaging device, such as a camera, relative to a board or the like, based on localization, in the image produced by the device, of reference patterns on the board. The invention also relates to apparatus adapted to put the method into practice.

In “Visual servoing in PCB manufacture” by F. de Jong and P. P Jonker (Proc. ASCI 2000, 6^{th} Annual Conference of the Advanced School for Computing and Imaging, ASCI, Delft, 2000, eds. L. J. van Vliet, J. W. J. Heijnsdijk, T. Kielman and P. M. W. Knijnenburg, pages 59-63) a method was proposed for estimating the position of the field of view of a camera with respect to a board, in this case a circuit board on which electronic components were to be placed. The camera is carried by a robot used for positioning the electronic components on the circuit board. The circuit board bears conductors which form geometrical patterns made up of straight segments. The proposed method involves determining the precise location of the camera's field of view based on the localization of several of these segments in the video image. The segments used in the method for estimating camera position can be termed “reference segments”. In this method, the image of the entire board is acquired and processed in order to detect and localize the reference segments.

A position-estimation technique based on detection of reference groups of segments will have greater accuracy if a large number of reference groups is used. However, in practice, the time required for localizing each reference group puts an upper limit on the number of groups that can be processed. Extensive testing of all the different possible sub-sets of reference groups that could be used would take too long. For example, choosing a set of 10 reference groups from amongst 25 possible ones would involve testing of more than 10¹² combinations. However, an arbitrary selection of reference groups will not ensure maximal accuracy of the position estimation, because some reference groups of segments are better suited than others to enabling an accurate estimate to be made of the position of the camera's field of view.

It is an object of the present invention to provide, in a method of estimating the position of the field of view of an imaging device (such as a camera) relative to a board based on localization of reference groups of markings, a selection technique adapted to select from among the various possible unambiguous reference groups those which are well-suited to enabling the position estimation to be performed accurately and/or rapidly.

The present invention provides a method of estimating the position of the field of view of an imaging device relative to a board having markings visible thereon, the method comprising the steps of: estimating the position of the field of view of the imaging device based on changes in position of a selected set of reference groups of markings; and selecting a set of reference groups of markings by application of a genetic algorithm optimization process wherein candidate sets of reference groups constitute respective individuals of a population.

In preferred embodiments of the invention, the selecting step of the position-estimating method comprises application of a genetic algorithm optimization process wherein a plurality of generations of individuals is generated, and the individual having the highest measure of a fitness parameter is selected to provide the set of reference groups to be used in position estimation.

By making use of a genetic algorithm to select the set of reference groups to be used in the position-estimation procedure, the present invention enables the selection to be optimized without involving inordinate amounts of processing. Moreover, use of a genetic algorithm enables the criteria underlying the selection to be changed, or new criteria to be added, with ease.

Preferably, the method according to the invention includes the steps of defining a plurality of candidate reference groups, each candidate reference group consisting of one or more markings on the board, and the field of view of the imaging device being at a first position relative to the board when the candidate reference groups are at a nominal position in the field of view of the imaging device; generating an image of at least a portion of the board by the imaging device; for each selected reference group, detecting the image of the respective selected reference group, and determining the offset between the position of the selected reference group in the field of view of the imaging device and said nominal position of the selected reference group; estimating the position of the field of view of the imaging device based on the determined offsets and based on the known relationship between the first position of the imaging device and the nominal position of the selected reference groups.

An advantage provided by preferred embodiments of the present invention is that, in the genetic algorithm used for selecting the reference markings, they employ a fitness parameter which seeks to optimize both the precision of the eventual position estimate and the speed of calculation.

In the preferred embodiment of the invention, it is advantageous if the fitness parameter used in the selecting step is a parameter seeking to minimize the inverse of the smallest singular value in a matrix A, where s=A/c, s being a Victoria representation of the offsets of the selected reference groups and c being the position of the field of view of the imaging device. The fitness parameter used in the selecting step may alternatively or additionally include a component seeking to minimize the total number of markings in the set of selected reference groups, and thereby to reduce processing time. The fitness parameter used in the selecting step may alternatively or additionally include a component seeking to minimize the proportion of markings occurring in common in different selected reference groups.

In the genetic algorithm optimization process used in the present invention, a selection may be made of individuals having the highest measure of a fitness parameter and these individuals used to generate the next generation. Alternatively or additionally, a selection may be made, based on a stochastic selection method, of individuals to be used to generate the next generation. Still further, one or more processes can be used to generate the individuals of a new generation, and these processes can include crossover and/or mutation.

In the genetic algorithm optimization process used in the present invention, in order to keep processing time within reasonable levels, an upper limit can be set on the number of reference groups that can be included in a candidate set of reference groups constituting an individual of the genetic algorithm optimization process. Preferably this upper limit is set based on the time required to localize each reference group in an image generated of at least a portion of the board.

In the position-estimation method of the present invention, the step of defining the plurality of candidate reference groups preferably comprises analyzing the board to identify unambiguously-identifiable groups of one or more markings. Moreover, it is advantageous if the markings constituting the reference groups are straight line segments.

More especially, it is preferred that the position-estimation method of the present invention should involve detection and localization of reference groups only in images of respective selected subsets of the board. By avoiding acquisition of the image of the entire board, the position-estimation can be significantly speeded-up. Using a priori knowledge concerning the maximal positional error of the camera it can be ensured that the analyzed subset images correspond to regions where the respective reference groups of segments are sure to appear.

In particular, the size of the subset images can be minimized, whilst still ensuring that the reference groups can be detected, if the subset image is a strip-shaped image line of length at least equal to or longer than twice the maximal positioning error of the imaging device. The reference segments are then straight-line segments extending over a distance equal to or longer than twice the maximal positioning error, with the line-shaped image region being substantially perpendicular to the reference segments. More details of this preferred aspect of the invention can be found in the applicant's co-pending European patent application entitled “Choice of Reference Markings for Enabling Fast Estimating of the Position of an imaging Device”, filed on the same day as the present application.

The present invention further provides apparatus having means for carrying out at least the reference group selection step of the above-described method. Preferably, the invention provides a system comprising a suitably programmed computer or a special purpose processor having circuit means which are arranged to implement at least the reference group selection step according to the above-described method. The present invention yet further provides a computer program product comprising a set of instructions for carrying out the above-described method. The apparatus, system or computer program product may be adapted to perform both the reference group selection step and the position estimation step of the method.

The invention and additional features, which may be optionally used to implement the invention to advantage, are apparent from and elucidated with reference to the drawings described hereinafter.

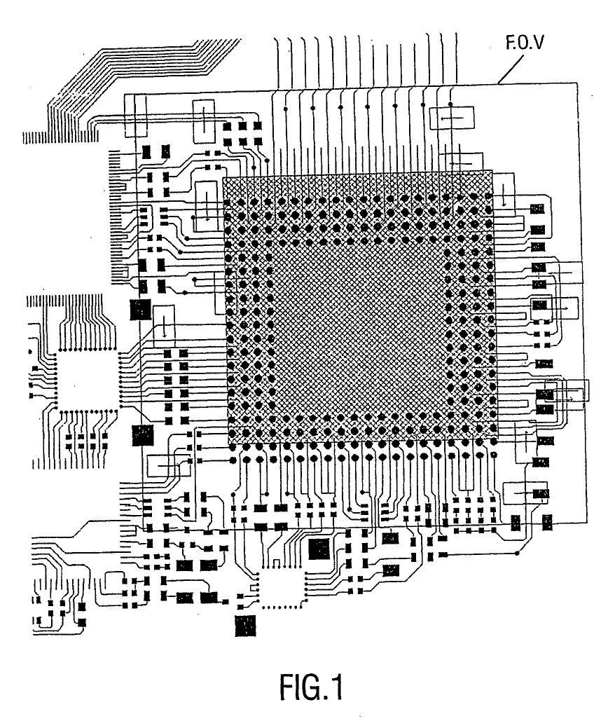

FIG. 1 is a schematic representation of the design of one example of a portion of a circuit board bearing straight-line conductor segments;

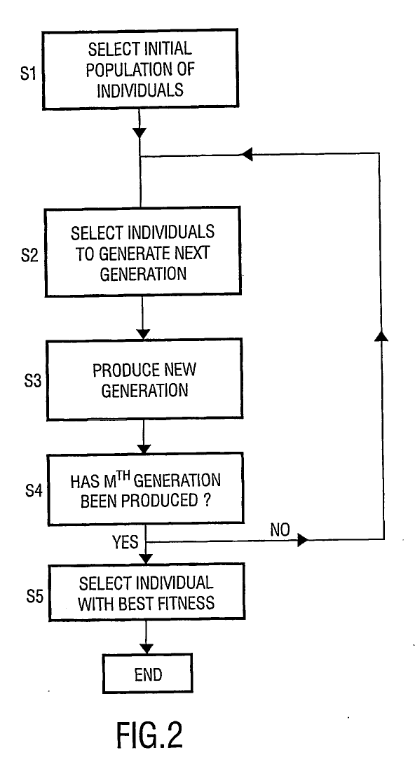

FIG. 2 is a flow chart illustrating the main steps of a genetic algorithm used in preferred embodiments of the present invention;

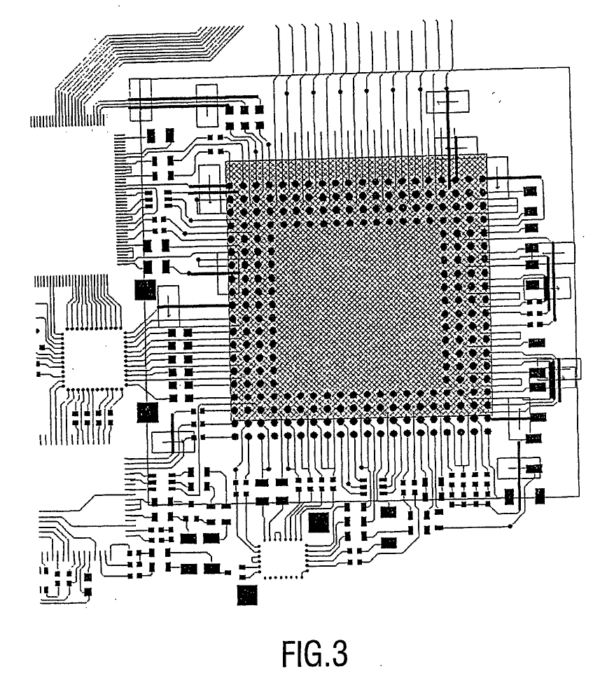

FIG. 3 is a schematic representation of the circuit board portion of FIG. 1, showing reference groups of segments selected according to a preferred embodiment of the present invention;

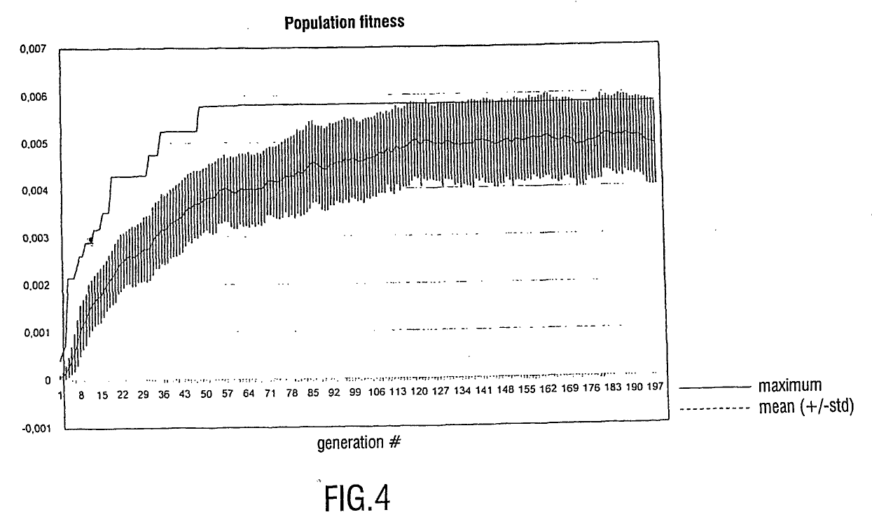

FIG. 4 is a graph illustrating how the average fitness of a population, and the fitness of the best individual, change over multiple generations of a genetic algorithm used in one embodiment of the present invention; and

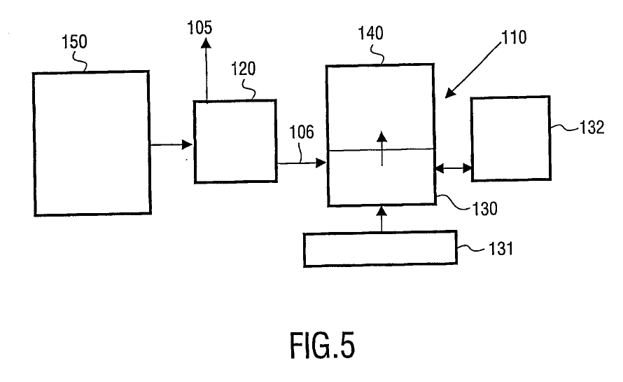

FIG. 5 is a schematic representation of an apparatus suitable for putting into practice the method according to the present invention.

In the position-estimation method of the present invention, it is possible to use different techniques to identify different possible candidate groups of segments that could be used in the position-estimation process. For instance, techniques described in the de Jong et al paper cited supra could be used. However, it is preferred to use the techniques described in the applicant's above-mentioned co-pending patent application. Accordingly, no further detail of this initial identification process will be given here, except to recall that the expression “a group of segments” includes a group made up of a single segment. It should also be recalled that although the expression “segment” here covers markings having different shapes, the preferred markings are straight-line segments.

Further, references to “unambiguous” groups of reference segments denote groups of segments that can be differentiated (for example, based on their orientation and/or spacing) from any other group of segments present within an error window centered on the nominal position of the group of reference segments. The error window is a region in which the group of reference segments is certain to appear and has dimensions equal to twice the maximal positioning error of the imaging device. For example, if a camera's position is accurate to ii mm, then the error window will have dimensions 2 mm×2 mm.

Also, no further details will be given here regarding the way in which reference groups of segments are used to enable an estimate to be made of the position of the field of view of an imaging device. The reader is referred instead to the applicant's above-mentioned co-pending application or to the de Jong et al paper cited supra.

The present invention concerns itself primarily with the way in which a selection is made, from amongst different candidate reference groups of segments, in order to choose a set of reference groups of segments for use in estimating the position of an imaging device with respect to a board displaying those reference segments.

The preferred embodiment of the present invention will be described below in the context of an application in which the position of the field of view of a camera is estimated with respect to a circuit board, with a view to ensuring accurate placement of electronic components upon the board. In this application, the camera will be repeatedly aligned with new circuit boards having the same layout of conductors, and with the sites of different conductors on each board. However, the present invention is not limited to this application. On the contrary, it is applicable in general to cases where the position of the field of view of an imaging device is to be estimated with respect to a board displaying straight-line segments, or other markings.

FIG. 1 is a schematic representation of the design of a portion of a circuit board on which electronic components are to be placed. The circuit board already has conductors defined thereon. In FIG. 1 the black square labeled FOV indicates the position of the field of view of the camera when the camera is at a first position relative to the board. The hatched square indicates a region of the board that is masked from the camera. Various items may mask portions of the board from the camera. In this case, the camera forms part of a robot placing components on the board and the robot mechanism and/or a component being held thereby can mask the board from the camera. Similarly, components that have already been placed on the board may mask certain portions of the board from the camera. An analysis of the straight-line conductor portions in the camera's field of view, using techniques described in the applicant's above-mentioned co-pending application, shows that it is possible to define 30 unambiguous groups of straight-line segments upon this board.

During the position-estimation procedure, the time, t_{RG}, required to process a reference group (that is to detect the group and determine the offset in its position) can be specified with reasonable precision. Also, in the application of placing electronic components on a circuit board it is generally necessary to repeat the position-estimation procedure at a given frequency, f_{PE}. Thus, there is an upper limit, N, on the number of reference groups of segments that can be used for the position estimation, N=1÷(t_{RG}×f_{PE}). The present invention provides a technique for making an optimal selection of reference groups for use in the position-estimation procedure.

According to the present invention, a genetic algorithm is used in which the individuals of the population correspond to respective different sets of candidate reference groups. For a given individual, it can be considered that the component candidate reference groups are the individual's genes. Preferably each individual of the population has the same number of genes (component candidate reference groups). Although all the individuals of the population are different, some genes may be present in more than one different individual.

The principle of genetic algorithms is to generate an initial population of individuals and then, iteratively, to manipulate this population to produce a subsequent generation, and select the best individuals out of this generation for use in producing the next generation, etc. The aim is to develop individuals that are increasingly valuable when assessed according to a “fitness” parameter.

The present invention makes use of a variety of genetic algorithms using different approaches for manipulating the individuals of one generation to produce the next, and using different criteria for assessing “fitness” of the individuals in the population. However, the basic approach followed in preferred embodiments of the present invention is as represented in the flow chart of FIG. 2.

As seen from FIG. 2, in a first step (S1) an initial population of individuals is chosen. This choice may be made by randomly selecting different sub-sets of the possible candidate reference groups. In an example described below, the initial population consists of 500 individuals (sub-sets of candidate reference groups). The number of genes per individual (candidate reference groups per sub-set) will generally be set taking into account the time that will be taken to process any given sub-set of reference groups during the position-estimation procedure (as discussed above).

Next, in step S2 of FIG. 2, a selection is made, from amongst the initial population, of those individuals that will produce the next generation. This selection can consist of choosing those individuals of the initial population that have the highest value of a “fitness” parameter. However, it can also be advantageous to use other, stochastic selection methods so as to increase the diversity of the population.

The next generation of individuals is then produced from the selected individuals, for example by crossover and/or mutation (step S3). Crossover consists in creating individuals having genes (component candidate reference groups) that are already present in the population of parent individuals. Mutation consists in creating individuals having genes that are not already present in the population of parent individuals.

Steps S2 and S3 are repeated for a fixed number, M, of generations. In the example discussed below M is 200. By appropriate adaptation of this genetic algorithm the average fitness of the population increases. A note is kept of the individual having the highest value of the fitness parameter. This individual is not necessarily present in the final generation. This individual is chosen to provide the set of reference groups that will be used in the position-estimation procedure.

In preferred embodiments of the present invention, the genetic algorithm makes use of a fitness parameter designed to maximize the accuracy of the position estimate that will be yielded using the selected set of reference groups. This fitness parameter will be better understood from the explanation below.

In position estimation, the procedure for estimating camera position may be summarized as follows:

a set of N unambiguous reference groups, {pᵢ}_{i=1, . . . ,N}, is selected in the predicted camera field of view;

these reference groups are detected in image data generated by the camera and a calculation is made of the offset or shift, s=[sᵢ]_{i=, . . . ,N}, in position thereof relative to a nominal position;

the relationship between the shift vector, s, and the camera position c is assumed to be linear (s=A/c) such that the camera position c can be estimated by least squares inversion, as follows:

c=(A^{t}·A)⁻¹A^{t}·s=M·s

Matrix A, and thus matrix M (M=(A^{t}·A)⁻¹A^{t}), is determined by the positions of the unambiguous reference groups that are selected for use in the position estimation procedure.

It is advantageous if the selected reference groups can be chosen such that measurement errors that corrupt the shift vector have as little influence as possible on the estimated position. If the exact position of the camera is c=M·s then the estimate affected by measurement error will be c′=M·(s+δs)=c+M·δs. Thus it is desirable to minimize M·δs for all values of δs. This implies that it is desirable to minimize the norm of matrix M or, looked at another way, to minimize the inverse of the smallest singular value of matrix A. Thus, in preferred embodiments of the invention, the genetic algorithm evaluates the “fitness”, f, of different individuals as follows:

f=exp {−(minimum singular value of A)⁻¹/T},

where T denotes a tuning parameter, analogue to temperature in Gibb's formula. The value of T affects the way in which the average fitness of the population evolves over different generations. If T is set too high, there will be little apparent difference between the fitness of different individuals of a given generation. If T is set too low, then the average fitness can increase dramatically in the first few generations but subsequently may not evolve towards the best possible value. In practice, T is generally set, as is known in the field of genetic algorithms, such that the average fitness of the population will increase over a number of generations and, by the time a desired number of generations has been produced, the average fitness will have reached a plateau corresponding to a relatively high value of fitness.

The fitness parameter can be adapted so as to take into account other factors which affect the accuracy of the ultimate position estimate. For example, if some of the reference groups in the selected set have segments in common then an error in estimating the positional offset of these segments will have an exaggerated effect. Thus, the fitness parameter can be adapted to include a component minimizing the number of segments common to the different reference groups of an individual.

Similarly, the fitness parameter can be adapted so as to take into account other factors besides maximizing the accuracy of the ultimate position estimate. For example, if processing speed is critical the “fitness” parameter can be adapted to include a component related to processing speed. Since processing speed depends upon the total number of segments in the selected set of reference groups, the fitness parameter can seek to minimize the total number of segments in the reference groups of the selected individual.

The fitness parameter can be adapted to include all three of the components mentioned above, with suitable weighting factors T₁ to T₃, in which case the fitness parameter may be evaluated, as follows:

f=exp{−(minimum singular value of A)⁻¹/T₁−(total number of segments)/T₂−(number of segments in common)/T₃}.

In general, the values of any weighting factors used in the fitness parameter will be set depending upon the relative importance that the user attaches to the different criteria (precision of position estimate, speed of calculation, etc.) corresponding to the various components in the fitness parameter. Thus, in many cases it can be possible to maintain the same values of the weighting factors even when a change is made in the design of the board for which reference markings are being selected.

The above-described approach was used to select an optimal set of 15 reference groups from amongst the 30 candidate reference groups identified for the circuit board portion of FIG. 1. In this example, 500 sub-sets of 15 candidate reference groups were selected at random from among the various possible combinations of 30 unambiguous reference groups. 200 generations were produced. The measure of fitness that was used was the three-component fitness parameter mentioned above, with T₁=5, T₂=10 and T₃=10.

In order to produce the next generation, a random selection was made from amongst the members of the current population, the probability of a given individual being selected being proportional to the value of the fitness parameter for that individual. Standard crossover and mutation techniques were used to produce the next generation. More particularly, when producing the next generation there was a 0.5% chance that any given reference group in a “parent” individual would be removed, and a 60% chance that for any given pair of reference groups in an individual one of the groups would undergo crossover. The set of 15 reference groups that was selected by this procedure is indicated by marking the selected reference groups in bold lines in FIG. 3.

The mean fitness of the individuals under consideration did indeed increase during the genetic-algorithm-based selection process of this example, as illustrated in the graph of FIG. 4. However, the individual with a highest measure of the fitness parameter appeared at around the 65^{th} generation. It was this individual that was chosen to provide the set of reference groups to be selected. Incidentally, even if the algorithm of this example is repeated using identical parameters the individual with highest fitness can appear in a different generation, due to the random nature of certain of the choices inherent in the algorithm.

The present invention provides apparatus for putting the above-described method into practice, as represented schematically in FIG. 5.

Referring to FIG. 5, the apparatus according to the invention incorporates a digital processing system 120 for processing data in order to implement at least the genetic algorithm selection process described above. The digital processing system 120 may be adapted to perform the initial identification of unambiguous reference groups present on the board, or it may receive data identifying these unambiguous reference groups. Furthermore, the digital processing system 120 may be adapted both to perform the selection of reference groups of markings and to perform the processing involved in detecting and localizing the selected reference groups and calculating the estimate of the position of the camera's field of view.

In a case where the processing system 120 performs the position estimation, as well as implementing the genetic algorithm, image data acquisition means 150 provides image data to the processing system 120. The image data acquisition means 150 may incorporate an imaging device or may be an interface (physical, or software-implemented) receiving image data from an imaging device viewing the board.

The processing system generally has at least one output (in this example the processing system 120 has two outputs 105, 106). The processing system 120 may output data indicating its selection of reference groups, and/or position estimate data, to display and/or storage means 130, 140, via the first output 106. Typically position estimate data will be in the form of numerical data but any convenient representation could be used (for example, a graphical representation showing the estimated position of the camera's field of view relative to a representation of the board). The display and storage means may respectively be the screen 140 and the memory 130 of a workstation 110. Said storage means may alternatively be external storage means.

In a case where the processing system 120 performs only the selection of reference groups, and a separate processing means (not shown) performs the detection and localization of reference groups and the calculation of the position estimate, the processing means 120 outputs data identifying the selected set of reference groups to this other processing means, via the output 105.

The data processing system 120 may be a suitably programmed computer of the workstation 110, or a special purpose processor having circuit means such as Look-Up Tables (LUTs), Memories, Filters, Logic Operators, that are arranged to perform the functions of the method steps according to the invention. The workstation 110 may also comprise a keyboard 131 and a mouse 132. The processing system 120 may use a computer program product having program instructions to be executed by the computing means of said processing system in order to carry out the above-described method.

The drawings and their description hereinbefore illustrate rather than limit the invention. It will be evident that there are numerous alternatives that fall within the scope of the appended claims. In this respect the following closing remarks are made.

The present invention has been described in the context of estimating the position of the field of view of a camera relative to a circuit board bearing segments constituted by conductor paths, with a view to enabling circuit components to be placed accurately on these paths. As mentioned above, the invention is not limited to this application and, specifically, references herein to a “board” refer to any medium bearing markings that can be imaged. Furthermore, references to a “camera” should be understood as covering varied kinds of imaging devices not limited to conventional still or video cameras. Moreover, the color of the markings and of the board under consideration is immaterial to the present invention so long as there is a discernible contrast between the markings and the board.

Furthermore, the present invention can make use of any appropriate techniques known in the field of genetic algorithms, beyond those specifically described above. For example, various techniques are known whereby it is not necessary to fix beforehand the number of generations that will be produced during the implementation of the genetic algorithm. Instead, the production of new generations stops automatically when predetermined conditions are fulfilled. This technique, amongst others, can be employed in embodiments of the present invention.

Any reference sign in a claim should not be construed as limiting the claim.

1. A method of estimating the position of the field of view of an imaging device relative to a board having markings visible thereon, the method comprising the steps of:
estimating the position of the field of view of the imaging device based on changes in position of a selected set of reference groups of markings; and
selecting a set of reference groups of markings by application of a genetic algorithm optimization process wherein candidate sets of reference groups constitute respective individuals of a population.

2. The position-estimation method of claim 1, wherein the selecting step comprises application of a genetic algorithm optimization process wherein a plurality of generations of individuals is generated, and the individual having the highest measure of a fitness parameter is selected to provide the set of reference groups to be used in position estimation.

3. The position-estimation method of claim 1 or 2, and comprising the steps of:
defining a plurality of candidate reference groups, each candidate reference group consisting of one or more markings on the board, and the field of view of the imaging device being at a first position relative to the board when the candidate reference groups are at a nominal position in the field of view of the imaging device;
generating an image of at least a portion of the board by the imaging device;
for each selected reference group, detecting the image of the respective selected reference group, and determining the offset between the position of the selected reference group in the field of view of the imaging device and said nominal position of the selected reference group; and
estimating the position of the field of view of the imaging device based on the determined offsets and based on the known relationship between the first position of the imaging device and the nominal position of the selected reference groups.

4. The position-estimation method of claim 1, 2 or 3, wherein the fitness parameter used in the selecting step is a parameter comprising a component seeking to minimize the inverse of the smallest singular value in a matrix A, where s=A/c, s being a Victoria representation of the offsets of the selected reference groups and c being the position of the field of view of the imaging device.

5. The position-estimation method of any previous claim, wherein the fitness parameter used in the selecting step is a parameter comprising a component seeking to minimize the total number of markings in the set of selected reference groups, and thereby to reduce processing time.

6. The position-estimation method of any previous clam, wherein the fitness parameter used in the selecting step is a parameter comprising a component seeking to minimize the proportion of markings occurring in common in different selected reference groups.

7. The position-estimation method of any previous claim, wherein, in the genetic algorithm optimization process, a selection is made of individuals to be used to generate the next generation, the selected individuals comprising individuals having the highest measure of a fitness parameter.

8. The position-estimation method of any previous claim, wherein, in the genetic algorithm optimization process, a selection is made of individuals to be used to generate the next generation, the selected individuals comprising individuals chosen using a stochastic selection method.

9. The position-estimation method of any previous claim wherein, in the genetic algorithm optimization process, at least one process is used to generate the individuals of a new generation, said at least one process comprising crossover.

10. The position-estimation method of any previous claim wherein, in the genetic algorithm optimization process, at least one process is used to generate the individuals of a new generation, said at least one process comprising mutation.

11. The position-estimation method of any previous claim, wherein there is an upper limit on the number of reference groups that can be included in a candidate set of reference groups constituting an individual of the genetic algorithm optimization process, said upper limit being related to the time required to localize each reference group in the generated image.

12. The position-estimation method of any previous claim, wherein the step of defining the plurality of candidate reference groups comprises analyzing the board to identify unambiguously-identifiable groups of one or more markings.

13. The position-estimation method of any previous claim, wherein the step of defining the plurality of candidate reference groups comprises defining candidate reference groups each comprising one or more straight line segments.

14. The position-estimation method of any previous claim, wherein the step of generating an image of at least a portion of the board by the imaging device comprises, for each selected reference group, generating an image of a respective subset of the board corresponding to the nominal position of the reference group; and the step of detecting the image of the respective selected reference group comprises localizing the selected reference group in said subset image.

15. Apparatus having means adapted to implement at least the reference group selection step of the method according to any previous claim.

16. A system comprising a suitably programmed computer or a special purpose processor having circuit means which are arranged to perform at least the reference group selection step of the method according to any one of claims 1 to 14.

17. A computer program product comprising a set of instructions for carrying out at least the reference group selection step of the method according to any one of claims 1 to 14.

18. An apparatus, system or computer program product according to claim 15, 16 or 17, and adapted to implement the position estimation step of the method according to any one of claims 1 to 14.
